(19) United States
(12) Patent Application Publication
(10) Pub. No.: US 2003/0063324 A1
(43) Pub. Date: Apr. 3, 2003

(54) Method of controlling a data transmission and communication apparatus that transmits image data in burst mode using the user datagram protocol

(76) Inventor: Tatsuo Takaoka, Kanagawa (JP)

Correspondence Address: Ivan S. Kavrukov, Cooper & Dunham LLP, 1185 Avenue of the Americas, New York, NY, 10036, US

(21) Appl. No.: 10/234,625

(22) Filed: Sep. 4, 2002

(30) Foreign Application Priority Data
Sep. 7, 2001 (JP) 2001-272428

(51) Int. Cl. H04N 1/00

(52) U.S. Cl. 358/404; 358/402

(57) ABSTRACT

A method of controlling data transmission for a communication apparatus includes a step in which a communication apparatus is informed of a receiving buffer size of a counterpart of communication, a step of determining data transmission speed at which image data are transmitted as user datagram procedure packets by comparing the receiving buffer size of the communication counterpart and a reference memory size, and a step of transmitting the user datagram packets of the image data in a burst transmission mode. The communication apparatus can determine the data transmission speed so that it can transmit image data in a burst transmission mode with a minimum risk of data loss.

### BACKGROUND OF THE INVENTION

1. Field of the Invention

The present invention relates to a communication apparatus provided with facsimile communication function to transmit data in a burst mode through a packet exchange network using the User Datagram Protocol (UDP).

2. Description of the Related Art

The International Telecommunication Union has recently defined recommendation T.38 for facsimile communication through the Internet. In this recommendation, a protocol that enables pseudo-real time communication through the Internet is defined. The recommendation T.38 is basically applicable to an Internet facsimile apparatus that provides a group 3 facsimile apparatus connected to an analog public telephone network with a gateway function.

However, if Internet facsimile apparatuses are provided with group 3 facsimile functions, they can exchange facsimile data with each other through communications following the T.38 recommendation.

In this specification, communication apparatuses such as a facsimile apparatus provided with the T.38 recommendation communication function are referred to as “T.38 terminals”. T.38 terminals can exchange data at the data transmission speed of the packet exchange network.

The T.38 recommendation has two data transmission modes, the Transmission Control Protocol (TCP) mode and the User Datagram Protocol (UDP) mode. A T.38 terminal can select either the TCP mode or the UDP mode when it starts communication.

The TCP mode, compared to the UDP mode, maintains the reliability of data communication at a higher level since the TCP mode controls data flow in the transmission layer, but the downside is that the data flow control takes time, which results in a lower speed in data communication.

On the other hand, the UDP mode assures higher speed data communication because no data flow control is performed, but it inherits the risk of missing data, which results in a lower reliability of transmitted data.

In the case where a T.38 terminal is connected to a local area network (LAN), the T.38 terminal can transmit an image file in a burst transmission mode, which enables the T.38 terminal to transmit the image file at the maximum data transmission speed available through the LAN. One can expect that the data transmission in a burst mode requires a much shorter time than in another mode. If too large a file is transmitted in a burst mode through the LAN, however, the LAN is overloaded, and consequently, other users may suffer difficulties in communicating through the LAN.

### SUMMARY OF THE INVENTION

Accordingly, it is a general object of the present invention to provide a novel and useful communication apparatus by which one or more of the problems described above are eliminated.

Another and more specific object of the present invention is to provide a communication apparatus that can communicate in the UDP mode in an appropriate manner and communication method.

To achieve the above objects, a method of controlling data transmission for a communication apparatus, according to the present invention, includes the steps of receiving control data from a communicating counterpart indicating receiving buffer size thereof, determining data transmission speed based on the relationship between said receiving buffer size indicated in said control data from said communication counterpart and a reference memory size provided to said communication apparatus beforehand, and transmitting image data to said communicating counterpart at the determined data transmission speed in a burst transmission mode.

The communicating counterpart informs the communication apparatus of the receiving buffer size so that the communication apparatus can determine data transmission speed based on the comparison between the receiving datagram buffer size and the reference memory size. Accordingly, the communication apparatus can transmit image data in a burst transmission mode at the data transmission speed with a minimum risk of data loss since the data transmission speed is determined at an appropriate level.

In another aspect of the present invention, a communication apparatus includes a gateway unit that exchanges data with a communicating counterpart through a packet exchange network, and a control unit that receives control data from said communicating counterpart through said gateway unit, said control data indicating receiving buffer size thereof, determining data transmission speed based on a relationship between said receiving buffer size indicated in said control data from said communication counterpart and a reference memory size, and causing said gateway unit to transmit image data to said communicating counterpart at the determined data transmission speed in a burst transmission mode.

Other objects, features, and advantages of the present invention will become more apparent from the following detailed description when read in conjunction with the accompanying drawings.

### BRIEF DESCRIPTION OF THE DRAWINGS

FIG. 1 is a schematic drawing showing a communication system according to an embodiment of the present invention;

FIG. 2 is a block diagram showing the structure of an Internet facsimile apparatus FX (FX1 or FX2) according to an embodiment;

FIG. 3 is a schematic diagram showing a data transmission procedure between T.38 terminals according to an embodiment;

FIG. 4 is a schematic drawing showing optional information for UDP;

FIGS. 5A and 5B show a flow chart of a process according to an embodiment in which an Internet facsimile apparatus FX transmits an image file to another Internet facsimile apparatus using the T.38 recommendation procedure;

FIG. 6 is a flow chart showing a step of determining data transmission speed (step 121 showed in FIG. 5A) according to an embodiment;

FIG. 7 is a flow chart showing a step of determining data transmission speed (step 121 showed in FIG. 5A) according to another embodiment;

FIG. 8 is a table showing ranges of a difference between the-maximum receiving datagram buffer size and a predetermined value, and corresponding data transmission speed;

FIGS. 9A and 9B show a flow chart of a process according to another embodiment in which an Internet facsimile apparatus FX transmits an image file to another Internet facsimile apparatus using T.38 recommendation procedure;

FIG. 10 is a flow chart showing a step of determining data transmission speed (step 421 showed in FIG. 9A) according to an embodiment;

FIG. 11 is a flow chart showing a step of determining data transmission speed (step 421 showed in FIG. 9A) according to another embodiment;

FIGS. 12A and 12B show a flow chart of a process according to yet another embodiment in which an Internet facsimile apparatus FX transmits an image file to another Internet facsimile apparatus using the T.38 recommendation procedure;

FIGS. 13A and 13B show a flow chart of a process according to yet another embodiment in which an Internet facsimile apparatus FX transmits an image file to another Internet facsimile apparatus using the T.38 recommendation procedure;

FIG. 14 is a flow chart showing a step of determining data transmission speed (step 821 showed in FIG. 13B) according to an embodiment;

FIG. 15 is a table showing ranges of a difference between the maximum receiving datagram buffer size and a predetermined value, and corresponding delay time;

FIG. 16 is a flow chart showing a step of determining data transmission speed according to another embodiment; and

FIG. 17 is a flow chart showing a step of determining delay time (step 821 showed in FIG. 13A)

### DETAILED DESCRIPTION OF THE PREFERRED EMBODIMENTS

The preferred embodiments of the present invention will be described in detail below in conjunction with the accompanying drawings.

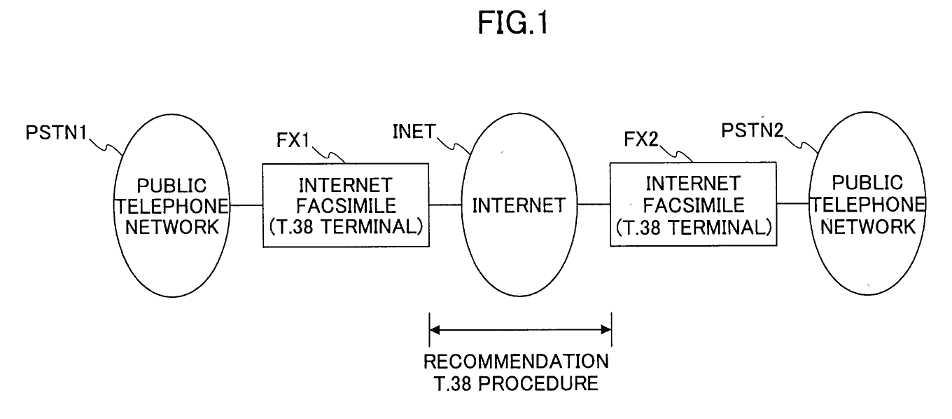

FIG. 1 is a schematic drawing showing a communication system according to an embodiment of the present invention.

This communication system includes two Internet facsimile apparatuses FX1 and FX2. Each Internet facsimile apparatus FX1 and FX2 is connected to analog public network PSTN 1 or PSTN 2 and the Internet INET. Each Internet facsimile apparatus FX1 and FX2 is provided with a group 3 facsimile apparatus function, ITU-T T.30 recommendation transmission function, real-time Internet gateway apparatus function and T.38 recommendation transmission function.

In this case, the Internet facsimile apparatuses FX1 and FX2 exchanges image files in compliance with the ITU-T recommendation T.38 procedure.

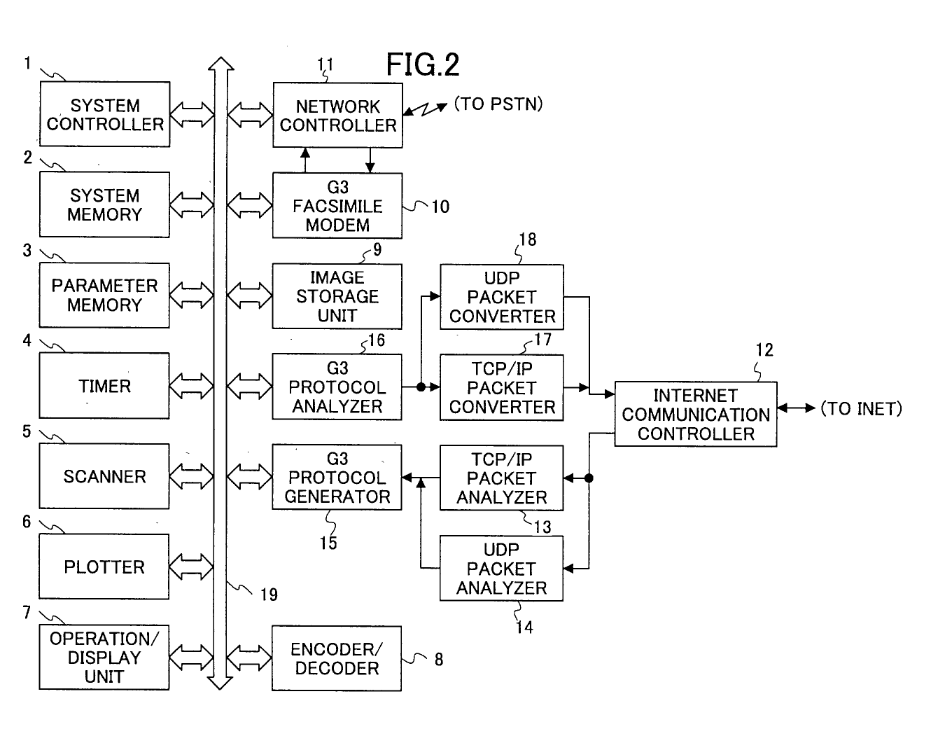

FIG. 2 is a block diagram showing the structure of the Internet facsimile apparatus FX (FX1 or FX2).

The Internet facsimile apparatus FX includes system controller 1, system memory unit 2, parameter memory unit 3, timer circuit 4, scanner 5, plotter 7, operational unit 7, encoder/decoder unit 8, and image storage unit 9.

System controller 1 performs various control functions. System controller 1 controls the operation of other functional units of the Internet facsimile apparatus FX, and further controls the communication of the Internet facsimile apparatus FX by following the facsimile transmission control procedure (ITU-T recommendation T.30 procedure) and the real-time transmission control procedure (ITU-T recommendation T.38 procedure).

System memory unit 2 stores a control program that is run by system controller 1, and various data that are used by system controller 1. System memory unit 2 provides system controller 1 with working memory area as well.

Parameter memory 3 stores information unique to this Internet facsimile apparatus FX. Timer circuit 4 outputs current time information.

Scanner 5 reads a document at a predetermined resolution, whereas plotter 6 outputs an image at a predetermined resolution. A user operates the Internet facsimile apparatus FX by operational unit 7, in which various operational keys and displays are provided.

Encoder/decoder unit 8 encodes image signals into image information for compression and decodes the compressed image information to the original image signal. Encoder/decoder unit 8 is mainly used for error detection in this case. Image storage unit 9 stores many items of encoded (consequently compressed) image information.

The Internet facsimile apparatus FX further includes network controller 11, group 3 facsimile modem 10, Internet communication controller 12, TCP/IP packet analyzer 13, UDP packet analyzer 14, group 3 protocol information generator 15, group 3 protocol analyzer 16, TCP/IP packet converter 17, and UDP packet converter 18.

Network controller 11 is used to connect this Internet facsimile apparatus FX to the analog public telephone network PSTN. Network controller 11 has an automatic transmission/reception function.

Group 3 facsimile modem 10 enables the Internet facsimile apparatus FX to communicate through the analog public telephone network PSTN, and can operate at a low speed mode (V.21 modem) in which transmission procedure signals are mainly exchanged and at a high speed mode (for example, V.17 modem, V.34 modem, V.29 modem, and V.27ter modem) in which image information is mainly exchanged.

Internet communication controller 12 enables the Internet facsimile apparatus FX to communicate through the Internet INET and exchange various data through the Internet INET. In TCP mode, the TCP/IP packet analyzer 13 analyzes TCP/IP packets received by Internet communication controller 12 to take out received information. In UDP mode, the UDP packet analyzer 14 analyzes UDP packets received by Internet communication controller 12 to take out the received information.

Group 3 protocol information generator 15, in the real-time transmission procedure, converts the received information taken out by TCP/IP packet analyzer 13 in TCP mode into corresponding group 3 transmission procedure signal information, and further converts the received information taken out by UDP packet analyzer 14 in UDP mode into corresponding group 3 transmission procedure signal information.

Group 3 protocol analyzer 16, in the realtime transmission procedure, separates the information of group 3 facsimile transmission procedure and outputs the information to TCP/IP packet converter 17 and UDP packet converter 18. TCP/IP packet converter 17, in TCP mode, converts the information of group 3 facsimile transmission procedure into TCP/IP packet data and outputs the data to Internet communication controller 12.

UDP packet converter 18 converts group 3 transmission procedure information output by group 3 protocol analyzer 16 into UDP packet data and sends the UDP packet data to Internet communication controller 12.

All of system controller 1, system memory unit 2, parameter memory unit 3, timer circuit 4, scanner 5, plotter 7, operational unit 7, encoder/decoder unit 8, image storage unit 9, network controller 11, group 3 facsimile modem 10, group 3 protocol information generator 15, and group 3 protocol analyzer 16 are connected to internal bus 17 and exchange data with each other through internal bus 17.

Network controller 11 and group 3 facsimile modem 10, however, exchange data directly.

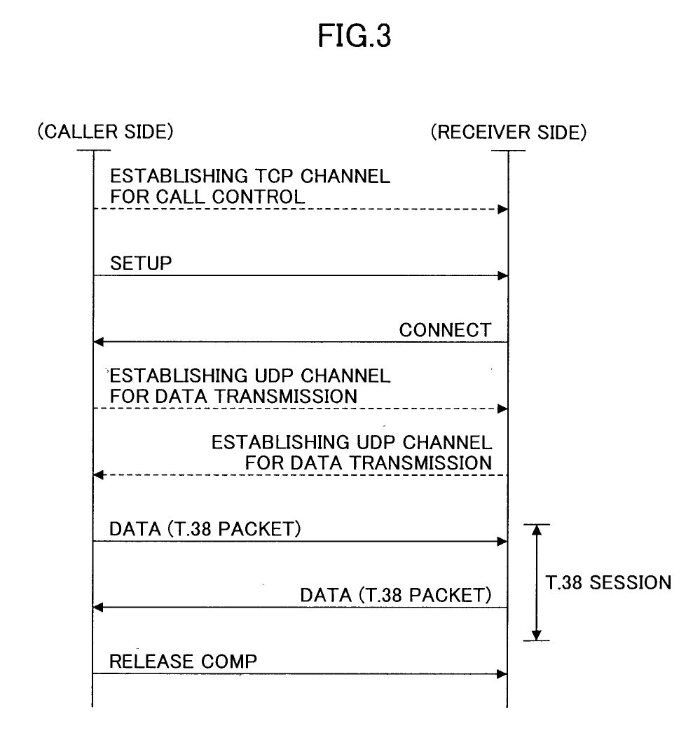

FIG. 3 is a schematic diagram showing a data transmission procedure between two Internet facsimile apparatuses according to an embodiment.

The caller side T.38 terminal establishes a TCP channel to the receiver side T.38 terminal, and then, the caller side T.38 terminal transmits a packet SETUP for call connection to the receiver side T.38 terminal.

In response to reception of the packet SETUP transmitted from the caller side T.38 terminal, the receiver side T.38 terminal returns a packet CONNECT to the caller side T.38 terminal. When the caller side T.38 terminal receives the packet CONNECT, a call between the caller side T.38 terminal and the receiver side T.38 terminal is established. The transport layer mode (TCP mode or UDP mode) and port numbers to be used are set by exchanging the packets SETUP and CONNECT.

Then, the caller side T.38 terminal establishes a UDP channel for transmitting data from the caller side to the receiver side. On the other hand, the receiver side T.38 terminal establishes a UDP channel for transmitting data from the receiver side to the caller side. Then, the caller side T.38 terminal and the receiver side T.38 terminal start exchanging image data through the two UDP channels under a T.38 session established in compliance with the T.38 recommendation.

When the two T.38 terminals finish exchanging the image data through the two UDP channels, the caller side T.38 terminal transmits a packet RELEASE COMP to discharge the receiver side T.38 terminal. This terminates the data communication between the caller side T.38 terminal and the receiver side T.38 terminal.

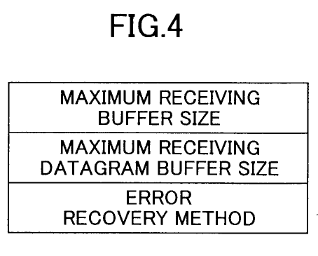

The packets SETUP and CONNECT includes information elements specified by the T.38 recommendation. The packet CONNECT further includes optional information items as showed in FIG. 4.

These information items constitute an information element called T38FaxUdpOptions. Maximum receiving buffer size refers to the buffer size in TCP mode. Maximum receiving datagram buffer size refers to the buffer size in UDP mode. Error recovery method refers to a value indicating either redundant packet method or EFC method.

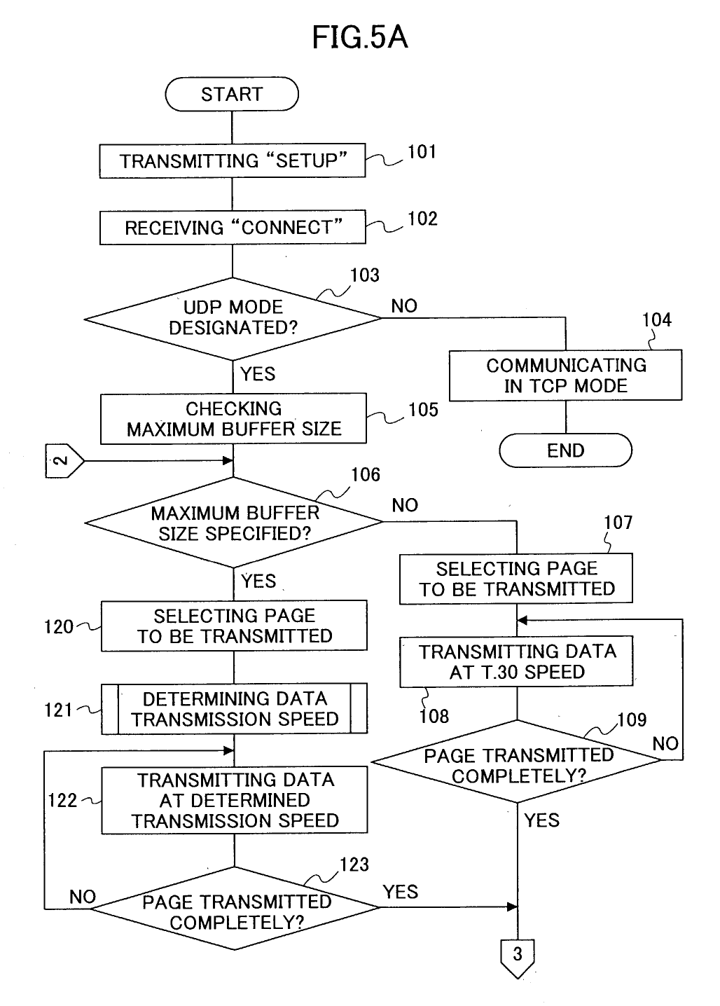

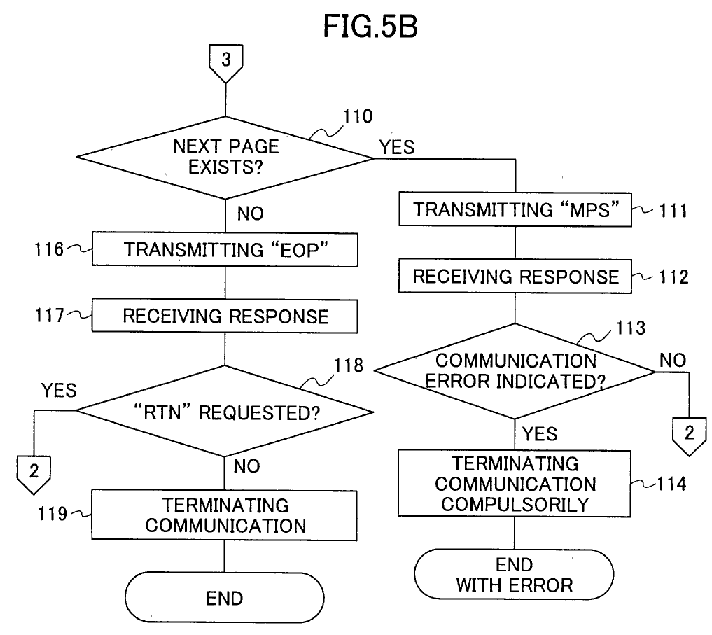

FIGS. 5A and 5B show a flow chart of a process according to an embodiment in which Internet facsimile apparatus FX transmits an image file to another Internet facsimile apparatus based on the T.38 recommendation procedure.

Internet facsimile apparatus FX transmits a packet “SETUP” to its counterpart (step 101), and receives a return packet “CONNECT” from the counterpart (step 102). Internet facsimile apparatus FX checks whether it is set at the UDP mode (step 103). If the result of step 103 is NO, Internet facsimile apparatus FX communicates with the counterpart in the TCP mode (step 104) and then, exits the process.

If Internet facsimile apparatus FX is set at UDP mode and the result of step 103 is YES, Internet facsimile apparatus FX checks whether the maximum receiving buffer size (maximum receiving datagram buffer size) is indicated in the packet CONNECT from the counterpart (steps 105 and 106).

In the case wherein no maximum receiving buffer size (maximum receiving datagram buffer size) is designated and the result of step 106 is NO, Internet facsimile apparatus FX communicates with its counterpart based on the recommendation T.38 procedure.

That is, Internet facsimile apparatus FX selects a page of the image file to be transmitted (step 107). If a new page is to be transmitted, the next page, that is, a page next to the page that has just been transmitted, is selected. If the page that has just been transmitted needs to be transmitted again, the same page is selected again.

Internet facsimile apparatus FX transmits image data at a data transmission speed based on recommendation T.30 until image data corresponding to the selected page are fully transmitted (step 108 and NO branch of step 109).

When the selected page has been fully transmitted and the result of step 109 turns to YES, Internet facsimile apparatus FX checks whether there still remains any page to be transmitted (step 110). If the result of step 110 is YES, Internet facsimile apparatus FX transmits a multi-page signal MPS as a post-message signal (step 111), and receives a response signal from the counterpart (step 112). If the response signal indicates that the counterpart detects a communication error (YES branch of step 113), Internet facsimile apparatus FX immediately and compulsorily terminates the transmission of the image file (step 114), and exits the process with an indication of the error.

In the case where Internet facsimile apparatus FX receives a message confirmation signal MCF indicating that the counterpart has received the image file normally, or in the case where Internet facsimile apparatus FX receives a retrain negative signal RTN requesting for resending the page that has just been transmitted, the result of step 113 is NO and Internet facsimile apparatus FX returns to step 106 to transmit the next page or resend the page that has just been transmitted.

When all pages of the image file have been transmitted and the result of step 110 is NO, Internet facsimile apparatus FX transmits an end-of-procedure signal EOP (step 116), and receives a response signal from the counterpart (step 117). If the response signal is a retrain negative signal RTN requesting for transmitting the same page again (YES branch of step 118), Internet facsimile apparatus FX returns to step 106 and transmits the same page (the page that has just been transmitted) again.

If Internet facsimile apparatus FX receives a response signal other than the retrain negative signal RTN and the result of step 118 is NO, Internet facsimile apparatus FX performs a predetermined procedure to terminate the communication (step 119) and exits the process normally.

On the other hand, if the maximum receiving buffer size (maximum receiving datagram buffer size) is designated and the result of step 106 is YES, Internet facsimile apparatus FX transmits the image file at an appropriate speed in a burst transmission mode.

Internet facsimile apparatus selects a page of the image file (step 120). If a new page is to be transmitted, the next page, that is, a page next to the page that has just been transmitted, is selected. If the page that has just been transmitted needs to be transmitted again, the same page is selected again.

Then, Internet facsimile apparatus FX determines data transmission speed by comparing the maximum receiving datagram buffer size and a reference memory size (described in detail later) (step 121). Internet facsimile apparatus FX transmits image data corresponding to the selected page in a burst mode at the speed determined in step 121 (step 122 and NO branch of step 123).

In the case where the image data corresponding to the selected page has been transmitted in the burst transmission mode and the result of step 123 is YES, Internet facsimile apparatus FX goes to step 110 to perform the process that follows.

The data transmission speed is adjustable by providing delay time to each UDP packet, for example.

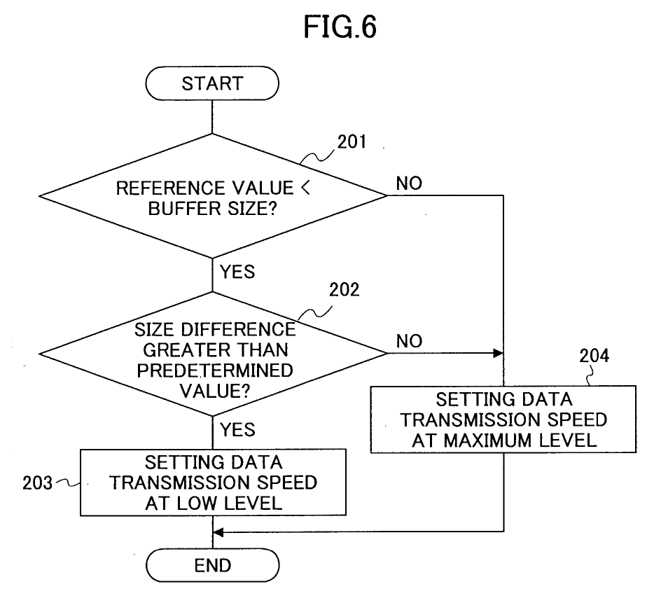

FIG. 6 is a flow chart showing a step of determining data transmission speed (step 121 showed in FIG. 5A) according to an embodiment.

Internet facsimile apparatus FX determines whether the maximum receiving datagram buffer size indicated by the counterpart is greater than a reference memory size (step 201).

If the result of step 201 is YES, Internet facsimile apparatus FX further determines whether the difference in memory size between the maximum receiving datagram buffer size and the reference memory size is greater than a predetermined value (step 202).

If the result of step 202 is YES, Internet facsimile apparatus FX sets the data transmission speed at a speed (8 MB/sec, for example) one step lower than the maximum speed (10 MB/sec, for example) available for communication through the Internet INET (step 203) and then, exits the process.

If the result of step 201 is NO, or the result of step 202 is NO, Internet facsimile apparatus FX sets the data transmission speed at the maximum speed available for communication through the internet INET (step 204) and then, exits the process.

The reference memory size is calculated based on one of the linear density of the image file to be transmitted (resolution), paper size, or image quality, or a combination of two or more of them.

The reference memory size is the data quantity contained in a page of a standard (reference) document under a certain transmission condition. For example, in the case where A4-sized documents are scanned and transmitted at a resolution of 400 dpi (dots/24.5 mm) and at a “regular” image quality, the reference memory size is equal to the data quantity contained in a page of the standard (reference) document under the same transmission condition. One can obtain a more realistic reference memory size that fits the actual condition in which Internet facsimile apparatus FX is used by adding the data quantity of the packet headers to the above reference memory size.

As described above, the counterpart of communication informs Internet facsimile apparatus FX according to an embodiment of the present invention of the maximum receiving buffer size (the maximum receiving datagram buffer size) so that the Internet facsimile apparatus FX can determine data transmission speed based on the comparison between the maximum receiving datagram buffer size and the reference memory size. Accordingly, the Internet facsimile apparatus FX can transmit image data in a burst transmission mode at the data transmission speed with a minimum risk of data loss since the data transmission speed is determined at an appropriate level.

Additionally, one can determine the data transmission speed so that the burst transmission of an image file by the Internet facsimile apparatus FX does not affect too much the communications between other entities through the network by appropriately determining the predetermined value used in step 203.

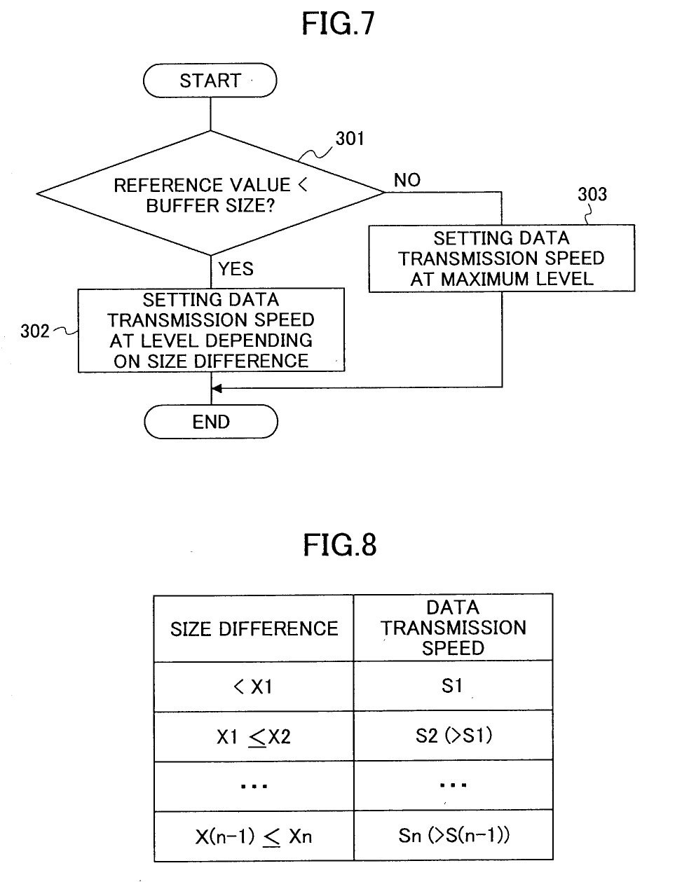

FIG. 7 is a flow chart showing a step of determining data transmission speed (step 121 showed in FIG. 5A) according to another embodiment.

The Internet facsimile apparatus FX determines whether the maximum receiving datagram buffer size provided by the counterpart is greater than the reference memory size (step 301).

If the result of step 301 is YES, the Internet facsimile apparatus FX determines the data transmission speed using the table showed in FIG. 8 based on the difference in memory size between the maximum receiving datagram buffer size and the reference memory size.

If the result of step 301 is NO, the Internet facsimile apparatus FX sets the data transmission speed at the maximum speed available for communication through the Internet INET (step 303) and exits the process.

In the table showed in FIG. 8, the size difference and the data transmission speed are related in the manner that the greater the difference in memory size between the maximum receiving datagram buffer size and the reference memory size is, the slower the data transmission speed is.

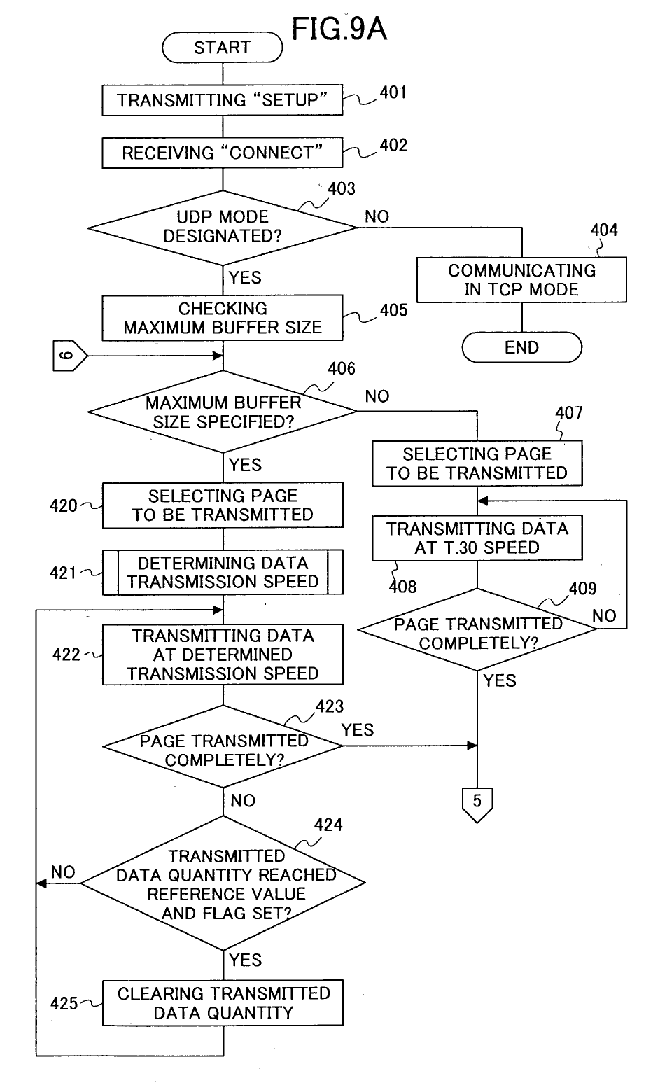

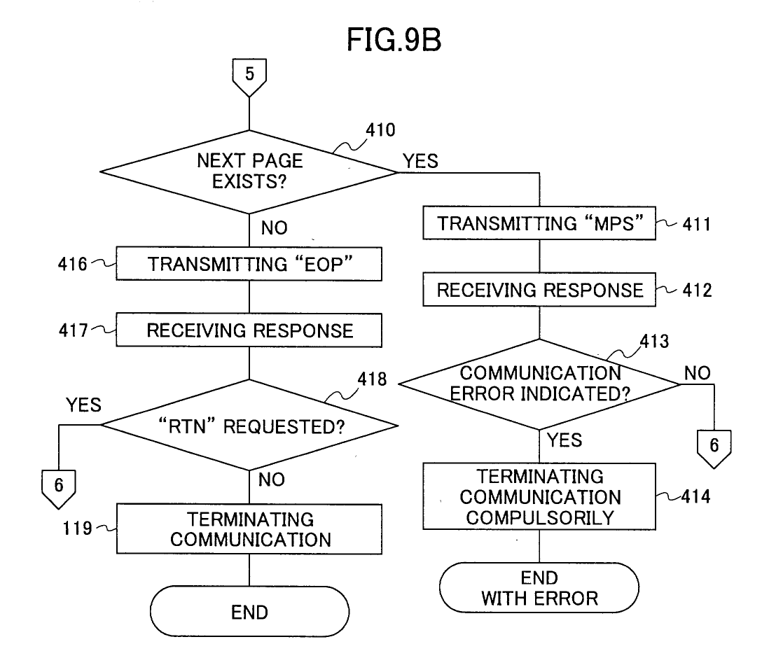

FIGS. 9A and 9B show a flow chart of a process according to another embodiment in which Internet facsimile apparatus FX transmits an image file to another Internet facsimile apparatus based on the T.38 recommendation procedure.

Internet facsimile apparatus FX transmits a packet “SETUP” to the counterpart of communication (step 401), and receives a packet “CONNECT” in response (step 402). Internet facsimile apparatus FX determines whether it is set in UDP mode (step 403). If the result of step 403 is NO, the Internet facsimile apparatus FX communicates with the counterpart in the TCP mode (step 404) and then, exits the process.

If Internet facsimile apparatus FX is set in UDP mode and the result of step 403 is YES, Internet facsimile apparatus FX checks whether the maximum receiving buffer size (maximum receiving datagram buffer size) is indicated in the packet CONNECT from the counterpart (steps 405 and 406).

In the case wherein no maximum receiving buffer size (maximum receiving datagram buffer size) is designated and the result of step 406 is NO, Internet facsimile apparatus FX communicates with its counterpart based on the recommendation T.38 procedure.

That is, the Internet facsimile apparatus FX selects a page of the image file to be transmitted (step 407). If a new page is to be transmitted, the next page, that is, a page next to the page that has just been transmitted, is selected. If the page that has just been transmitted needs to be transmitted again, the same page is selected again.

Internet facsimile apparatus FX transmits image data at a data transmission speed based on recommendation T.30 until image data corresponding to the selected page is fully transmitted (step 408 and NO branch of step 409).

When the selected page has been fully transmitted and the result of step 409 turns to YES, Internet facsimile apparatus FX checks whether there still remains any page to be transmitted (step 410). If the result of step 410 is YES, Internet facsimile apparatus FX transmits a multi-page signal MPS as a post-message signal (step 411), and receives a response signal from the counterpart (step 412). If the response signal indicates that the counterpart detects a communication error (YES branch of step 413), Internet facsimile apparatus FX immediately and compulsorily terminates the transmission of image file (step 414), and exits the process with an indication of the error.

In the case where Internet facsimile apparatus FX receives a message confirmation signal MCF indicating that the counterpart has received the image file normally, or in the case where Internet facsimile apparatus FX receives a retrain negative signal RTN requesting for resending the page that has just been transmitted, the result of step 413 is NO and Internet facsimile apparatus FX returns to step 406 to transmit the next page or resend the page that has just been transmitted.

When all pages of the image file have been transmitted and the result of step 410 is NO, Internet facsimile apparatus FX transmits an end-of-procedure signal EOP (step 416), and receives a response signal from the counterpart (step 417). If the response signal is a retrain negative signal RTN requesting for transmitting the same page again (YES branch of step 418), Internet facsimile apparatus FX returns to step 406 and transmits the same page (the page that has just been transmitted) again.

If Internet facsimile apparatus FX receives a response signal other than the retrain negative signal RTN and the result of step 418 is NO, Internet facsimile apparatus FX performs a predetermined procedure to terminate the communication (step 419) and exits the process normally.

On the other hand, if the maximum receiving buffer size (maximum receiving datagram buffer size) is designated and the result of step 406 is YES, Internet facsimile apparatus FX transmits the image file at an appropriate speed in a burst transmission mode.

Internet facsimile apparatus selects a page of the image file (step 420). If a new page is to be transmitted, the next page, that is, a page next to the page that has just been transmitted, is selected. If the page that has just been transmitted needs to be transmitted again, the same page is selected again.

Then, Internet facsimile apparatus FX determines data transmission speed by comparing the maximum receiving datagram buffer size and a reference memory size, and sets or resets a flag as well (step 421). Internet facsimile apparatus FX, while transmitting image data corresponding to the selected page in a burst mode (step 422), determines whether the image data corresponding to the selected page have been transmitted (step 423) and whether, in the case where the flag is set in step 421, the quantity of image data that has been transmitted reaches the reference memory size (NO branch of step 424).

In the case where the flag is set and, while the image data corresponding to the selected page are transmitted, the accumulative quantity of image data that has been transmitted reaches the reference memory size (the result of step 424 turns to YES) the image data transmission is terminated and the accumulative quantity is cleared (step 425). Internet facsimile apparatus FX returns to step 422 and transmits the remaining image data.

In the case where the image data corresponding to the selected page have been transmitted in the burst transmission mode and the result of step 423 is YES, Internet facsimile apparatus FX goes to step 410 to perform the process that follows.

The data transmission speed is adjustable by providing a delay time to each UDP packet, for example.

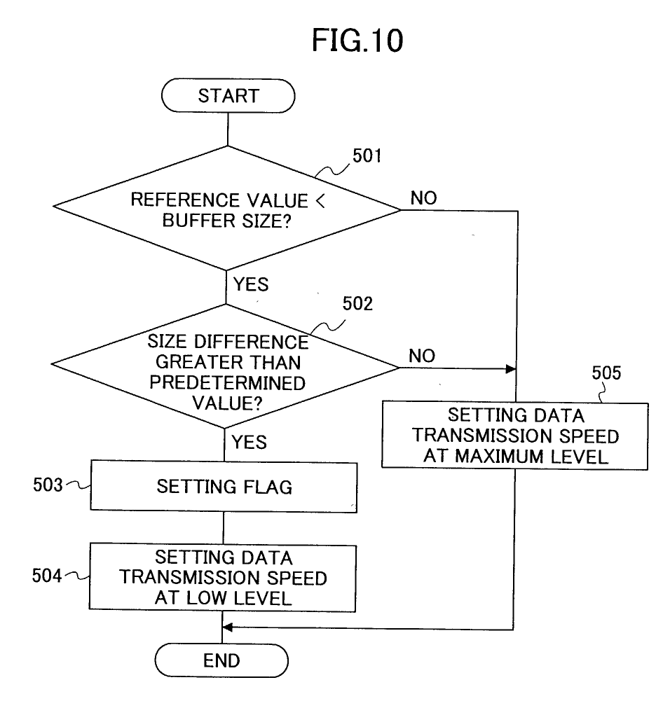

FIG. 10 is a flow chart showing a step of determining data transmission speed (step 421) according to another embodiment.

Internet facsimile apparatus FX determines whether the maximum receiving datagram buffer size indicated by the counterpart is greater than a reference memory size (step 501).

If the result of step 501 is YES, Internet facsimile apparatus FX further determines whether the difference in memory size between the maximum receiving datagram buffer size and the reference memory size is greater than a predetermined value (step 502).

If the result of step 502 is YES, Internet facsimile apparatus FX sets the flag (step 503) and further sets the data transmission speed at a speed (8 MB/sec, for example) one step lower than the maximum speed (10 MB/sec, for example) available for communications through the Internet INET (step 504) and then, exits the process.

If the result of step 501 is NO, or the result of step 502 is NO, Internet facsimile apparatus FX sets the data transmission speed at the maximum speed available for communication through the Internet INET (step 505) and then, exits the process.

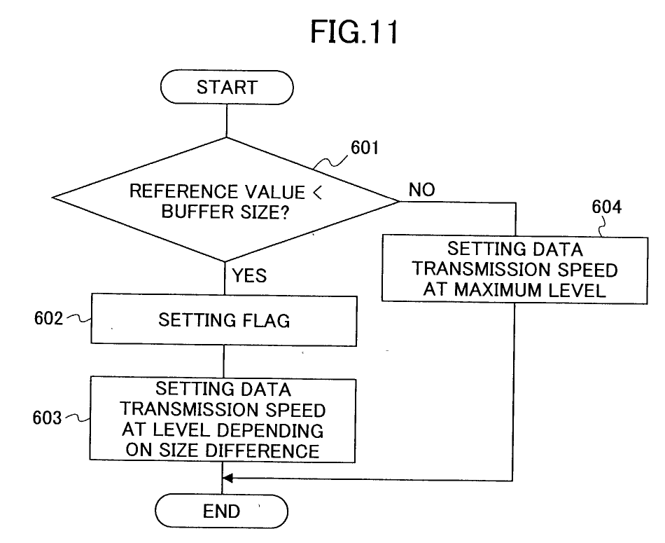

FIG. 11 is a flow chart showing a step of determining data transmission speed (step 421) according to yet another embodiment.

Internet facsimile apparatus FX determines whether the maximum receiving datagram buffer size indicated by the counterpart is greater than a reference memory size (step 601).

If the result of step 601 is YES, Internet facsimile apparatus FX sets the flag (step 602) and determines the data transmission speed by obtaining the difference in memory size between the maximum receiving datagram buffer size and the reference memory size by reference to the table showed in FIG. 8 (step 603).

If the result of step 601 is NO, Internet facsimile apparatus FX sets the data transmission speed at the maximum speed available for communications through the Internet INET (step 604) and then, exits the process.

As described above, the counterpart of communication informs Internet facsimile apparatus FX according to an embodiment of the present invention of the maximum receiving buffer size (the maximum receiving datagram buffer size) so that the Internet facsimile apparatus FX can determine data transmission speed based on the comparison between the maximum receiving datagram buffer size and the reference memory size. Accordingly, the Internet facsimile apparatus FX can transmit image data in a burst transmission mode at the data transmission speed with a minimum risk of data loss since the data transmission speed is determined at an appropriate level.

Additionally, one can determine the data transmission speed so that the burst transmission of an image file by the Internet facsimile apparatus FX does not affect too much the communications between other entities through the network by appropriately determining the predetermined value.

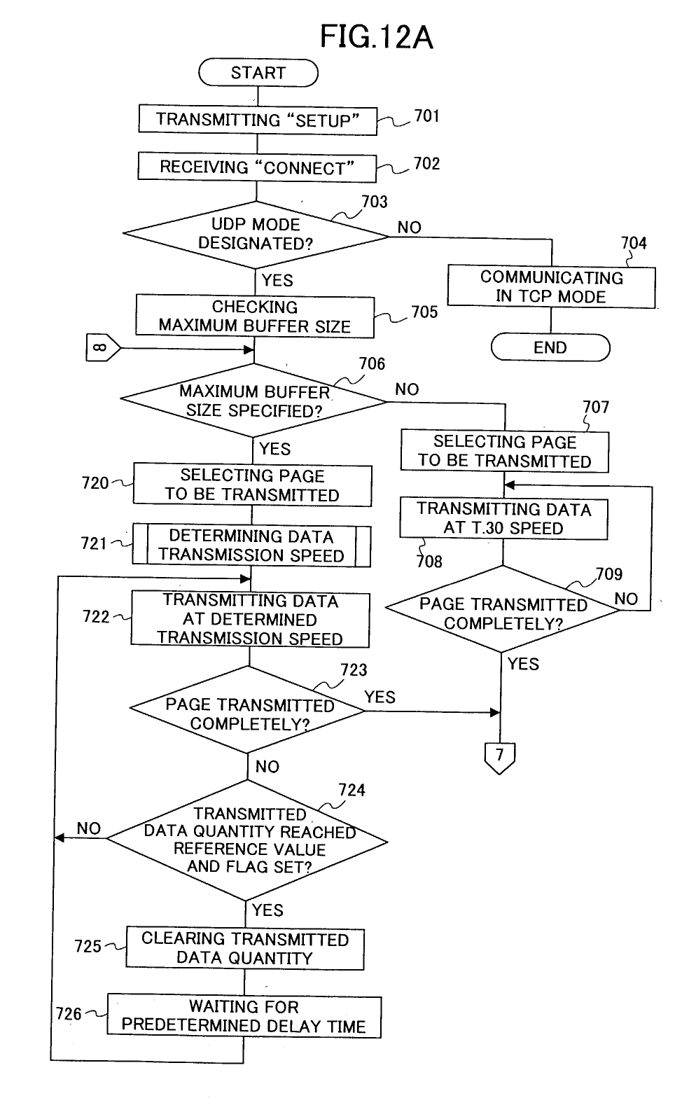

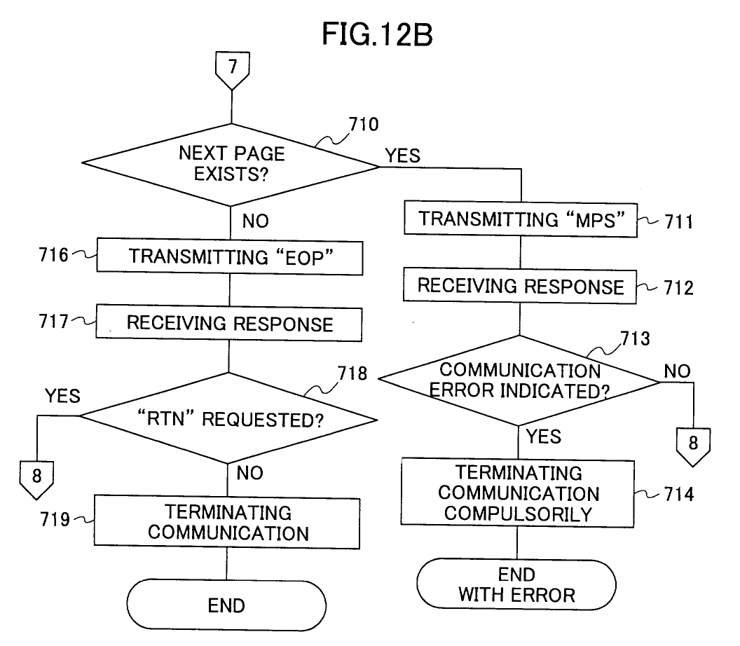

FIGS. 12A and 12B show a flow chart of a process according to yet another embodiment in which Internet facsimile apparatus FX transmits an image file to another Internet facsimile apparatus based on the T.38 recommendation procedure.

Internet facsimile apparatus FX transmits a packet “SETUP” to the counterpart of communication (step 701), and receives a packet “CONNECT” in response (step 702). Internet facsimile apparatus FX determines whether it is set at UDP mode (step 703). If the result of step 703 is NO, the Internet facsimile apparatus FX communicates with the counterpart in the TCP mode (step 704) and then, exits the process.

If Internet facsimile apparatus FX is set at UDP mode and the result of step 703 is YES, Internet facsimile apparatus FX checks whether the maximum receiving buffer size (maximum receiving datagram buffer size) is indicated in the packet CONNECT from the counterpart (steps 705 and 706).

In the case wherein no maximum receiving buffer size (maximum receiving datagram buffer size) is designated and the result of step 706 is NO, Internet facsimile apparatus FX communicates with its counterpart based on the recommendation T.38 procedure.

That is, the Internet facsimile apparatus FX selects a page of the image file to be transmitted (step 707). If a new page is to be transmitted, the next page, that is, a page next to the page that has just been transmitted, is selected. If the page that has just been transmitted needs to be transmitted again, the same page is selected again.

Internet facsimile apparatus FX transmits image data at a data transmission speed based on recommendation T.30 until image data corresponding to the selected page are fully transmitted (step 708 and NO branch of step 709).

When the selected page has been fully transmitted and the result of step 709 turns to YES, Internet facsimile apparatus FX checks whether there still remains any page to be transmitted (step 710). If the result of step 710 is YES, Internet facsimile apparatus FX transmits a multi-page signal MPS as a post-message signal (step 711), and receives a response signal from the counterpart (step 712). If the response signal indicates that the counterpart detects a communication error (YES branch of step 713), Internet facsimile apparatus FX immediately and compulsorily terminates the transmission of the image file (step 714), and exits the process with an indication of the error.

In the case where Internet facsimile apparatus FX receives a message confirmation signal MCF indicating that the counterpart has received the image file normally, or in the case where Internet facsimile apparatus FX receives a retrain negative signal RTN requesting for resending the page that has just been transmitted, the result of step 713 is NO and Internet facsimile apparatus FX returns to step 706 to transmit the next page or resend the page that has just been transmitted.

When all pages of the image file have been transmitted and the result of step 710 is NO, Internet facsimile apparatus FX transmits an end-of-procedure signal EOP (step 716), and receives a response signal from the counterpart (step 717). If the response signal is a retrain negative signal RTN requesting for transmitting the same page again (YES branch of step 718), Internet facsimile apparatus FX returns to step 706 and transmits the same page (the page that has just been transmitted) again.

If Internet facsimile apparatus FX receives a response signal other than the retrain negative signal RTN and the result of step 718 is NO, Internet facsimile apparatus FX performs a predetermined procedure to terminate the communication (step 719) and exits the process normally.

On the other hand, if the maximum receiving buffer size (maximum receiving datagram buffer size) is designated and the result of step 706 is YES, Internet facsimile apparatus FX transmits image file at an appropriate speed in a burst transmission mode.

Internet facsimile apparatus selects a page of the image file (step 720). If a new page is to be transmitted, the next page, that is, a page next to the page that has just been transmitted, is selected. If the page that has just been transmitted needs to be transmitted again, the same page is selected again.

Then, Internet facsimile apparatus FX determines data transmission speed and sets or resets a flag as well by performing the process showed in FIG. 10 or 11 (step 721).

Internet facsimile apparatus FX, while transmitting image data corresponding to the selected page in a burst mode at the data transmission speed determined in step 721 (step 722), determines whether the image data corresponding to the selected page have been transmitted (step 723) and whether, in the case where the flag is set in step 721, the quantity of image data that has been transmitted reaches the reference memory size (NO branch of step 724).

In the case wherein the flag is set and, while the image data corresponding to the selected page are transmitted, the accumulative quantity of image data that has been transmitted reaches the reference memory size (the result of step 724 turns to YES), the image data transmission is terminated and the accumulative quantity is cleared (step 725). Internet facsimile apparatus FX waits for the delay time determined at step 721 (step 726) and returns to step 722 to transmit the remaining image data.

In the case where the image data corresponding to the selected page have been transmitted in the burst transmission mode and the result of step 723 is YES, Internet facsimile apparatus FX goes to step 710 to perform the process that follows.

The data transmission speed is adjustable by providing delay time to each UDP packet, for example.

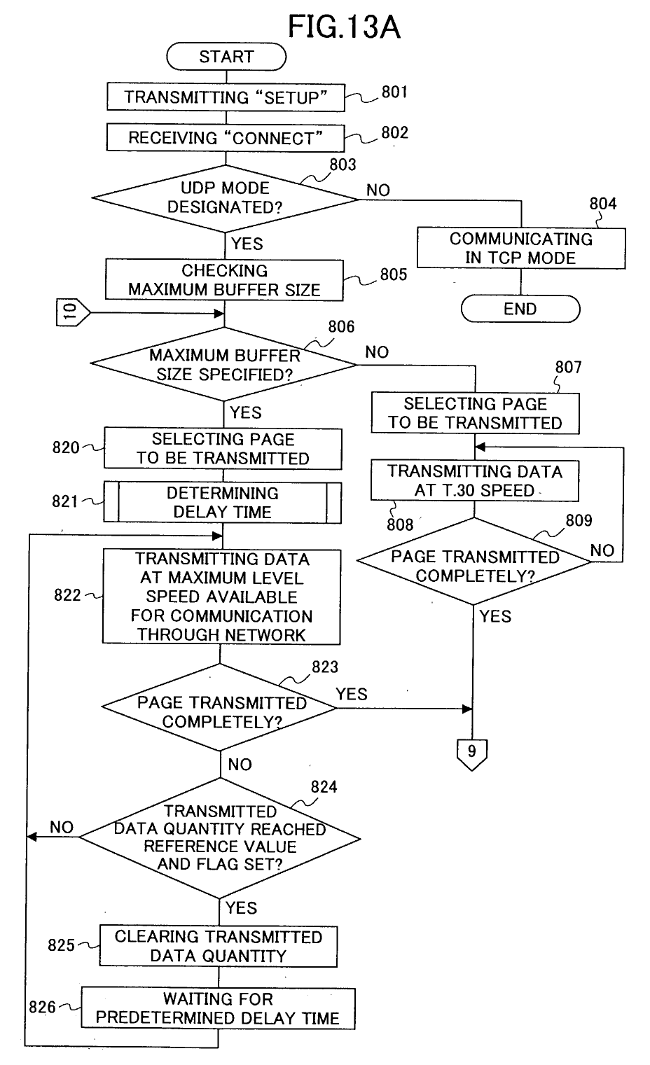

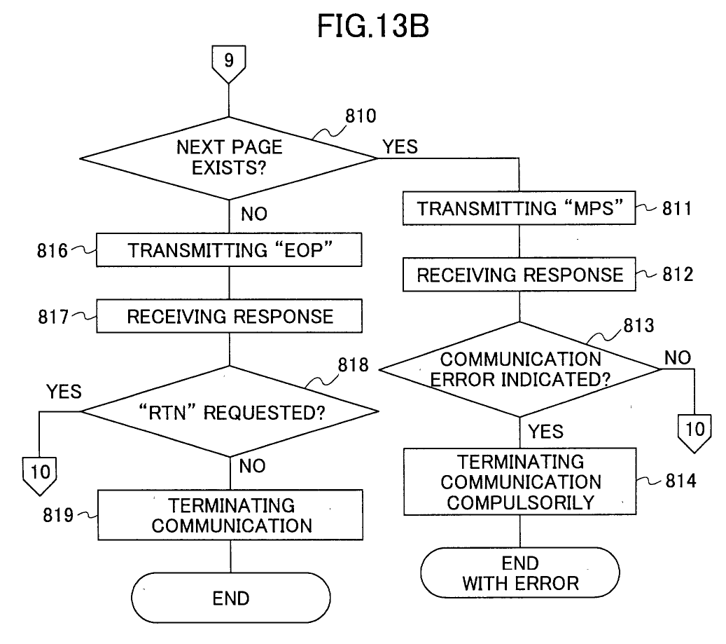

FIGS. 13A and 13B show a flow chart of a process according to yet another embodiment in which Internet facsimile apparatus FX transmits an image file to another Internet facsimile apparatus based on the T.38 recommendation procedure.

Internet facsimile apparatus FX transmits a packet “SETUP” to the counterpart of communication (step 801), and receives a packet “CONNECT” in response (step 802). Internet facsimile apparatus FX determines whether it is set at UDP mode (step 803). If the result of step 803 is NO, the Internet facsimile apparatus FX communicates with the counterpart in the TCP mode (step 804) and then, exits the process.

If Internet facsimile apparatus FX is set at UDP mode and the result of step 803 is YES, Internet facsimile apparatus FX checks whether the maximum receiving buffer size (maximum receiving datagram buffer size) is indicated in the packet CONNECT from the counterpart (steps 805 and 806).

In the case wherein no maximum receiving buffer size (maximum receiving datagram buffer size) is designated and the result of step 806 is NO, Internet facsimile apparatus FX communicates with its counterpart based on the recommendation T.38 procedure.

That is, the internet facsimile apparatus FX selects a page of the image file to be transmitted (step 807). If a new page is to be transmitted, the next page, that is, a page next to the page that has just been transmitted, is selected. If the page that has just been transmitted needs to be transmitted again, the same page is selected again.

Internet facsimile apparatus FX transmits image data at a data transmission speed based on recommendation T.30 until image data corresponding to the selected page are fully transmitted (step 808 and NO branch of step 809).

When the selected page has been fully transmitted and the result of step 809 turns to YES, Internet facsimile apparatus FX checks whether there still remains any page to be transmitted (step 810). If the result of step 810 is YES, Internet facsimile apparatus FX transmits a multi-page signal MPS as a post-message signal (step 811), and receives a response signal from the counterpart (step 812). If the response signal indicates that the counterpart detects a communication error (YES branch of step 813), Internet facsimile apparatus FX immediately and compulsorily terminates the transmission of the image file (step 814), and exits the process with an indication of the error.

In the case where Internet facsimile apparatus FX receives a message confirmation signal MCF indicating that the counterpart has received the image file normally, or in the case where Internet facsimile apparatus FX receives a retrain negative signal RTN requesting for resending the page that has just been transmitted, the result of step 813 is NO and Internet facsimile apparatus FX returns to step 806 to transmit the next page or resend the page that has just been transmitted.

When all pages of the image file have been transmitted and the result of step 810 is NO, Internet facsimile apparatus FX transmits an end-of-procedure signal EOP (step 816), and receives a response signal from the counterpart (step 817). If the response signal is a retrain negative signal RTN requesting for transmitting the same page again (YES branch of step 818), Internet facsimile apparatus FX returns to step 806 and transmits the same page (the page that has just been transmitted) again.

If Internet facsimile apparatus FX receives a response signal other than the retrain negative signal RTN and the result of step 818 is NO, Internet facsimile apparatus FX performs a predetermined procedure to terminate the communication (step 819) and exits the process normally.

On the other hand, if the maximum receiving buffer size (maximum receiving datagram buffer size) is designated and the result of step 806 is YES, Internet facsimile apparatus FX transmits the image file at an appropriate speed in a burst transmission mode.

Internet facsimile apparatus selects a page of the image file (step 820). If a new page is to be transmitted, the next page, that is, a page next to the page that has just been transmitted, is selected. If the page that has just been transmitted needs to be transmitted again, the same page is selected again.

Then, Internet facsimile apparatus FX determines delay time, and sets or resets the flag as well by comparing the maximum receiving datagram buffer size indicated by the counterpart and the reference memory size (step 821).

Internet facsimile apparatus FX, while transmitting image data corresponding to the selected page in a burst mode at the maximum data transmission speed available for communications through the Internet INET (step 822), determines whether the image data corresponding to the selected page have been transmitted (step 823) and whether, in the case where the flag is set in step 821, the quantity of image data that has been transmitted reaches the reference memory size (NO branch of step 824).

In the case where the flag is set and, while the image data corresponding to the selected page is transmitted, the accumulative quantity of image data that has been transmitted reaches the reference memory size (the result of step 824 turns to YES), the image data transmission is terminated and the accumulative quantity is cleared (step 825). Internet facsimile apparatus FX waits for the delay time determined at step 821 (step 826), and returns to step 822 and transmits the remaining image data.

In the case where the image data corresponding to the selected page has been transmitted in the burst transmission mode and the result of step 823 is YES, Internet facsimile apparatus FX goes to step 810 to perform the process that follows.

The data transmission speed is adjustable by providing delay time to each UDP packet, for example.

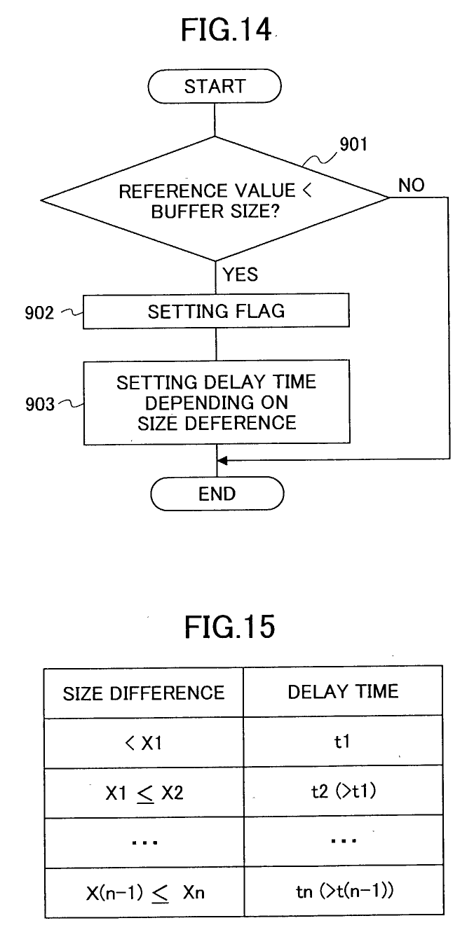

FIG. 14 is a flow chart showing a step of determining delay time (step 821) according to an embodiment.

Internet facsimile apparatus FX determines whether the maximum receiving datagram buffer size indicated by the counterpart is greater than a reference memory size (step 901).

If the result of step 901 is YES, Internet facsimile apparatus FX sets the flag (step 902) and determines the delay time by obtaining the difference in memory size between the maximum receiving datagram buffer size and-the reference memory size by reference to the table showed in FIG. 15 (step 903).

If the result of step 901 is NO, Internet facsimile apparatus FX does not perform steps 902 and 903.

In the table showed in FIG. 15, the size difference and the delay time are related in the manner that the greater the difference in memory size between the maximum receiving datagram buffer size and the reference memory size is, the greater the delay time is.

As described above, the counterpart of communication informs Internet facsimile apparatus FX according to an embodiment of the present invention of the maximum receiving buffer size (the maximum receiving datagram buffer size) so that the Internet facsimile apparatus FX can determine data transmission speed based on the comparison between the maximum receiving datagram buffer size and the reference memory size. Accordingly, the Internet facsimile apparatus FX can transmit image data in a burst transmission mode at the data transmission speed with a minimum risk of data loss since the data transmission speed is determined at an appropriate level.

Additionally, one can determine the data transmission speed so that the burst transmission of an image file by the Internet facsimile apparatus FX does not affect too much the communications between other entities through the network by appropriately determining the predetermined value.

Furthermore, since Internet facsimile apparatus FX delays data transmission for an appropriate delay time every time the accumulative data quantity reaches the reference memory size, the receiving buffer of the receiver size does not overflow. Accordingly, the data transmission speed is maximized and the risk of data loss is minimized.

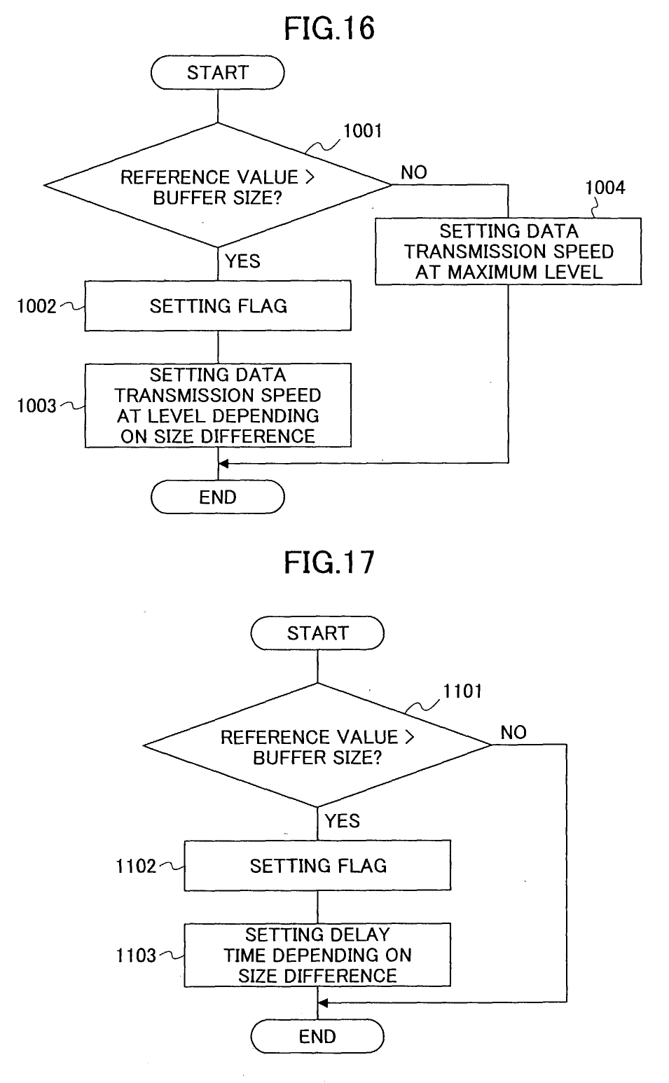

FIG. 16 is a flow chart showing a step of determining data transmission speed according to another embodiment.

Internet facsimile apparatus FX determines whether the maximum receiving datagram buffer size indicated by the counterpart is smaller than the reference memory size (step 1001).

If the result of step 1001 is YES, Internet facsimile apparatus FX sets the flag (step 1002) and determines the data transmission speed by obtaining the difference in memory size between the maximum receiving datagram buffer size and the reference memory size by reference to the table showed in FIG. 8 (step 1003).

If the result of step 1001 is NO, Internet facsimile apparatus FX sets the data transmission speed at the maximum speed available for communications through the Internet INET (step 1004) and then, exits the process.

FIG. 17 is a flow chart showing a step of determining delay time (step 821) according to yet another embodiment.

Internet facsimile apparatus FX determines whether the maximum receiving datagram buffer size indicated by the counterpart is greater than a reference memory size (step 1101).

If the result of step 1101 is YES, Internet facsimile apparatus FX sets the flag (step 1102) and determines the delay time based on the difference in memory size between the maximum receiving datagram buffer size and the reference memory size by reference to the table showed in FIG. 15 (step 1103).

If the result of step 1101 is NO, steps 1102 and 1103 are skipped.

In this case, since Internet facsimile apparatus FX checks whether the maximum receiving datagram buffer size is smaller than the reference memory size in order to determine the data transmission speed and the delay time, Internet facsimile apparatus FX can determine the data transmission speed and the delay time more appropriately.

The preferred embodiments of the present invention are described above. The present invention is not limited to these embodiments, but various variations and modifications may be made without departing from the scope of the present invention.

This patent application is based on Japanese priority patent application No. 2001-272428 filed on Sep. 7, 2001, the entire contents of which are hereby incorporated by reference.

What is claimed is:

1. A method of controlling data transmission for a communication apparatus, comprising the steps of:
receiving control data from a communicating counterpart indicating a receiving buffer size thereof;
determining data transmission speed based on a relationship between said receiving buffer size indicated in said control data from said communication counterpart and a reference memory size provided to said communication apparatus beforehand; and
transmitting image data to said communicating counterpart at the determined data transmission speed in a burst transmission mode.

2. The method as claimed in claim 1, wherein, if said receiving buffer size is greater than said reference memory size and a differential memory size between said receiving buffer size and said reference memory size is greater than a predetermined value, said data transmission speed is set at a level lower than the maximum available for a communication through a network.

3. The method as claimed in claim 2, wherein memory size is classified into a plurality of ranges and said data transmission speed is determined by identifying one of said ranges in which said differential memory size falls, each range corresponding to a different data transmission speed.

4. The method as claimed in claim 1, wherein, in a case in which said receiving buffer size is greater than said reference memory size and a differential memory size between said receiving buffer size and said reference memory size is smaller than a predetermined value, said data transmission speed is lowered when data quantity transmitted to said communicating counterpart exceeds said reference memory size.

5. The method as claimed in claim 4, wherein memory size is classified into a plurality of ranges and said data transmission speed is lowered by identifying one of said ranges in which said differential memory size falls, each range corresponding to a reduction of said data transmission speed.

6. The method as claimed in claim 1, wherein, in a case in which said receiving buffer size is greater than said reference memory size and a differential memory size between said receiving buffer size and said reference memory size is smaller than a predetermined value, said communication apparatus delays transmitting said data for a predetermined time when data quantity transmitted to said communicating counterpart exceeds said reference memory size.

7. The method as claimed in claim 6, wherein memory size is classified into a plurality of ranges and said predetermined time is determined by identifying one of said ranges in which said differential memory size falls, each range corresponding to a different predetermined time.

8. The method as claimed in claim 1, wherein, if said reference memory size is greater than said receiving buffer size, said communication apparatus delays transmitting said data for a predetermined time every time a predetermined data quantity has been transmitted to said communicating counterpart.

9. The method as claimed in claim 1, wherein, if said reference memory size is greater than said receiving buffer size, said data transmission speed is lowered.

10. The method as claimed in claim 1, wherein said reference memory size is functionally determined by one of linear density of image data, document size of said image data, or image quality information of said image data, or a combination thereof.

11. A communication apparatus, comprising:
a gateway unit that exchanges data with a communicating counterpart through a packet exchange network; and
a control unit that receives control data from said communicating counterpart through said gateway unit, said control data indicating a receiving buffer size thereof, determining a data transmission speed based on a relationship between said receiving buffer size indicated in said control data from said communication counterpart and a reference memory size, and causing said gateway unit to transmit image data to said communicating counterpart at the determined data transmission speed in a burst transmission mode.

12. The communication apparatus as claimed in claim 11, wherein, if said receiving buffer size is greater than said reference memory size and a differential memory size between said receiving buffer size and said reference memory size is greater than a predetermined value, said data transmission speed is set at a level lower than the maximum available for a communication through said packet exchange network.

13. The communication apparatus as claimed in claim 12, wherein memory size is classified into a plurality of ranges and said data transmission speed is determined by identifying one of said ranges in which said differential memory size falls, each range corresponding to a different data transmission speed.

14. The communication apparatus as claimed in claim 11, wherein, in a case in which said receiving buffer size is greater than said reference memory size and a differential memory size between said receiving buffer size and said reference memory size is smaller than a predetermined value, said data transmission speed is lowered when data quantity transmitted to said communicating counterpart exceeds said reference memory size.

15. The communication apparatus as claimed in claim 14, wherein memory size is classified into a plurality of ranges and said data transmission speed is lowered by identifying one of said ranges in which said differential memory size falls, each range corresponding to a reduction of said data transmission speed.

16. The communication apparatus as claimed in claim 11, wherein, in a case in which said receiving buffer size is greater than said reference memory size and a differential memory size between said receiving buffer size and said reference memory size is smaller than a predetermined value, said communication apparatus delays transmitting said data for a predetermined time when data quantity transmitted to said communicating counterpart exceeds said reference memory size.

17. The communication apparatus as claimed in claim 16, wherein memory size is classified into a plurality of ranges and said predetermine time is determined by identifying one of said ranges in which said differential memory size falls, each range corresponding to a different predetermined time.

18. The communication apparatus as claimed in claim 11, wherein, if said reference memory size is greater than said receiving buffer size, said communication apparatus delays transmitting said image data for a predetermined time every time a predetermined data quantity has been transmitted to said communicating counterpart.

19. The communication apparatus as claimed in claim 11, wherein, if said reference memory size is greater than said receiving buffer size, said data transmission speed is lowered.

20. The communication apparatus as claimed in claim 11, wherein said reference memory size is functionally determined by one of linear density of image data, document size of said image data, or image quality information of said image data, or a combination thereof.

21. A communication apparatus, comprising:
means for receiving control data from a communicating counterpart indicating a receiving buffer size thereof;
means for determining data transmission speed based on a relationship between said receiving buffer size indicated in said control data from said communication counterpart and a reference memory size provided to said communication apparatus beforehand; and
means for transmitting image data to said communicating counterpart at the determined data transmission speed in a burst transmission mode.
